(19) United States
(12) Patent Application Publication
(10) Pub. No.: US 2013/0224681 A1
(43) Pub. Date: Aug. 29, 2013

(54) DECORATIVE CUT-OUT FOR DENTAL DEVICE

(71) Applicant: Jason K. Smith, Cortez, AZ (US)

(72) Inventor: Jason K. Smith, Cortez, AZ (US)

(21) Appl. No.: 13/842,268

(22) Filed: Mar. 15, 2013

Related U.S. Application Data
(63) Continuation-in-part of application No. 12/774,526, filed on May 5, 2010.

(51) Int. Cl. A61C 19/00; A61C 17/02; A61C 1/00

(52) U.S. Cl. CPC A61C 19/00; A61C 1/0084; A61C 17/0208; A61C 17/0202
USPC 433/90; 29/557

(57) ABSTRACT

A decorative cut-out is provided for application to a dental device. The decorative cut-out includes a decorative design that incorporates a structural feature of the dental device to portray an object selected to alleviate an anxiety of a patient.

### RELATED APPLICATIONS

The present application is a continuation-in-part of U.S. patent application Ser. No. 12/774,526, filed May 5, 2010, and titled SYSTEMS AND METHODS FOR PROVIDING A DECORATIVE DENTAL TIP, which is incorporated herein, in its entirety.

### BACKGROUND OF THE INVENTION

1. Field of the Invention

The present invention relates to various devices to decorate a dental device. In particular, the present invention relates to decorative devices having a decorative surface to portray an object, such as an animal, a plant, a vehicle, and/or a cartoon character. At least some embodiments of the present invention further relate to methods for alleviating or reducing the anxiety of a patient, such as a child-patient. In particular, embodiments of the present invention relate to methods whereby a patient is given the option of choosing a decorative design that is compatible with a dental device.

2. Background and Related Art

Visits to the dentist's office can be a scary and anxiety provoking experience for many patients, particularly for child-patients. The fear and anxiety of being in a new environment, confronted by new faces and foreign instruments can stimulate a sympathetic nervous response in patients leading to such objective physical findings as increased heart rate, increased blood pressure, sweating, emotional liability, fidgeting, and reluctance to cooperate with the doctor's instructions. Most dentists and other doctors find it advantageous to try to relieve these fears and anxieties before and throughout a physical exam or procedure. This allows the child-patient to feel more at ease during the exam and cooperate with the examination and/or treatment procedures.

Some methods of alleviating a child-patient's anxieties include distracting the child by communicating with the child. Other methods of alleviating a child-patient's anxieties include distracting the child with a television monitor and a video presentation of child-patient's preference. Still further, some methods of distraction include administering an inhalation anesthetic, such as nitrous oxide, to the child-patient at a dosage that temporarily alleviates the patient's anxieties.

While each these methods have been shown to provide some benefits in reducing a patient's anxiety, none of these methods are directed towards reducing a patient's anxieties related to the instrumentation used by the dentist. Thus, while techniques currently exist that relate to alleviating the anxiety and/or nervousness of children patients, challenges still exist. Accordingly, it would be an improvement in the art to augment or even replace current techniques with other techniques.

### SUMMARY OF THE INVENTION

The present invention relates to decorative dental tips that are provided as a means of reducing the anxiety of a patient. In some implementations, a decorative dental tip is provided having a molded outer surface which portrays an object known to be visually appealing to the patient. A decorative dental tip may include a molded outer surface portraying an animal, a plant, a vehicle and/or a cartoon character. An interior lumen of the decorative dental tip is sized to receive an adapter portion of a dental syringe in a fluid-tight manner. The interior lumen further includes an opening whereby a fluid from the dental syringe is delivered to the patient via the decorative dental tip.

Implementations of the present invention further relate to methods for alleviating the anxiety of a patient. Some methods of the present invention includes steps whereby a patient selects a decorative dental tip, the doctor affixes the selected dental tip to the dental syringe, the dental syringe and tip are used for a dental procedure, and the dental tip is then removed from the dental syringe and given to the patient as a keepsake. A method of manufacture is further provided whereby a decorative dental tip is manufactured by first selecting an object that is visually appealing to a dental patient, followed by providing a dental tip having a molded outer surface that portrays the visually appealing object.

Implementations of the present invention further provide a decorative cut-out having a decorative surface on which is portrayed an animal, a plant, a vehicle and/or a cartoon character, wherein a physical or structural feature of a dental device correlates and contributes to the subject matter of the design on the decorative surface. The present invention further includes a computer software program for providing a desired decorative cut-out device.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 shows a flow chart of a representative system that provides a suitable operating environment in which various embodiments of the present invention may be implemented;

FIG. 2 shows a flow chart of a representative networking system that provides a suitable environment in which various embodiments of the present invention may be implemented;

FIG. 3 is a perspective view of a conventional water/air dental syringe fitted with a conventional disposable tip;

FIG. 4 is a perspective view of a conventional water/air dental syringe fitted with a decorative tip in accordance with a representative embodiment of the present invention;

FIG. 5 is a perspective view of a conventional water/air dental syringe fitted with a decorative tip, shown in cross-section, in accordance with a representative embodiment of the present invention;

FIG. 6A is a plan view of a two-dimensional decorative cut-out in accordance with various representative embodiments of the present invention;

FIG. 6B is a perspective view of the two-dimensional decorative cut-out shown in FIG. 6A fitted onto a dental device thereby providing a three-dimensional decorative cut-out in accordance with a representative embodiment of the present invention;

FIG. 7A is a plan view of a two-dimensional decorative cut-out in accordance with various representative embodiments of the present invention;

FIG. 7B is a perspective view of the two-dimensional decorative cut-out shown in FIG. 7A fitted onto a dental device thereby providing a three-dimensional decorative cut-out in accordance with a representative embodiment of the present invention;

FIG. 8 is a flow chart demonstrating various steps to a method for selecting and providing a decorative cut-out in accordance with a representative embodiment of the present invention; and

FIG. 9 is a flow chart demonstrating a computer process for selecting and providing a decorative cut-out in accordance with a representative embodiment of the present invention.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Various embodiments of the present invention relate systems and methods to decorate a dental tip. In particular, some embodiments of the present invention relate to a decorative, disposable dental tip having a molded outer surface shaped to portray an object, such as an animal, a plant, a vehicle, and a cartoon character. Other embodiments relate to a decorate cut-out having various apertures through which is fitted a dental tip or other dental device.

As used herein, the term “patient” generally refers to any dental patient and may specifically include a child-patient, an adolescent patient, an adult patient, and a patient prone to anxieties related to dentistry examinations and procedures.

As used herein, the terms “dental syringe” and “syringe” are used interchangeably to refer to a dental handpiece or instrument used to deliver water and/or air to the oral cavity of a patient, as well as remove or evacuate liquids and debris from the oral cavity. Various embodiments of the present invention may also be used with various other dental devices.

As used herein, the term “fluid” generally refers to any substance capable of flowing and may specifically include water, air, compressed water, compressed air, and combinations thereof.

As used herein, the term “metallic” generally refers to any material comprising metal or metal alloys that are compatible with the practice of dentistry.

As used herein, the term “plastic” generally refers to any polymer material compatible with the practice of dentistry, and may include composites and composite fiber materials.

As used herein, the term “sterilizable” generally refers to any procedure whereby contaminants and pathogens are removed from a surface of an object, and may include procedures such as using an autoclave, boiling an object in water, and applying steam to the object.

As used herein, the terms “soothing color” and “soothing pattern” refer generally to colors and patterns known in the art to provide a psychological and/or physiological effect on the patient thereby reducing the anxiety of the patient.

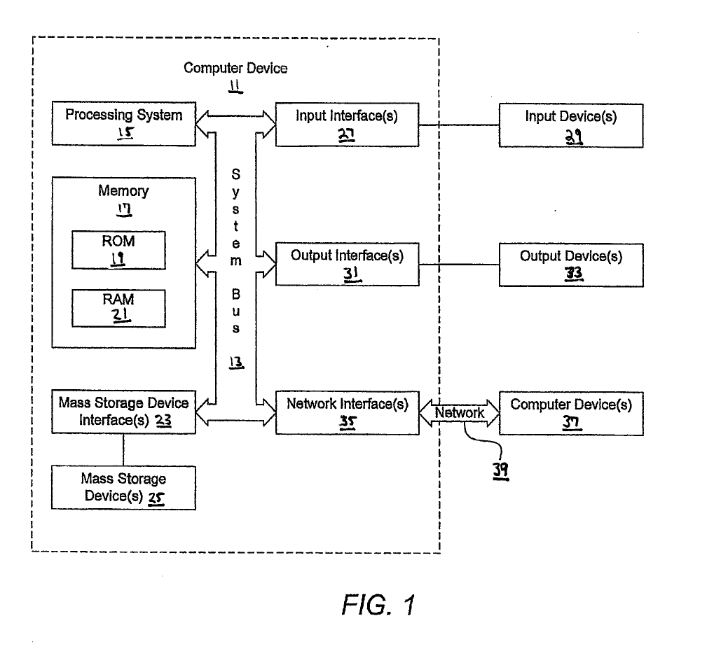

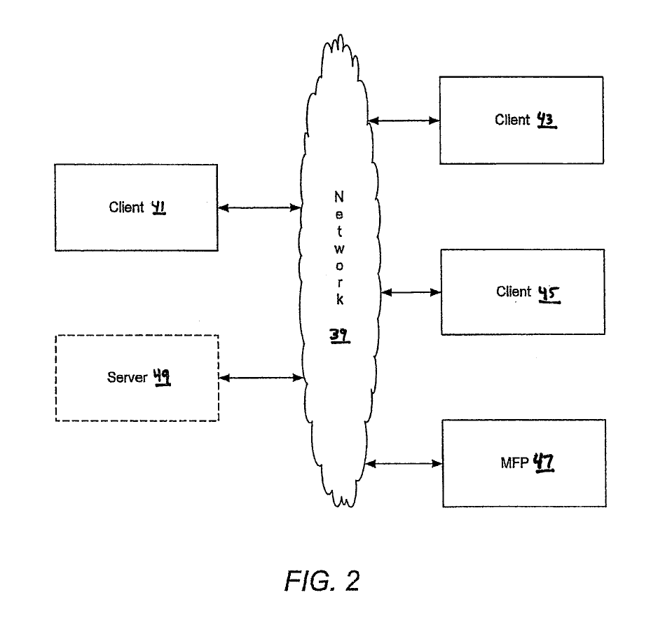

FIGS. 1 and 2, and the corresponding discussion, provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing embodiments of the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, a smart phone, a position identifier, a ball collector, or the like.

Computer device 10 may include a system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, thumb drives, solid state memory, a universal serial bus or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, thumb drive tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices (illustrated as multifunctional peripheral (MFP) MFP 46) across network 38. While FIG. 2 illustrates an embodiment that includes a client 40, two additional clients, client 42 and client 44, one peripheral device, MFP 46, and optionally a server 48, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

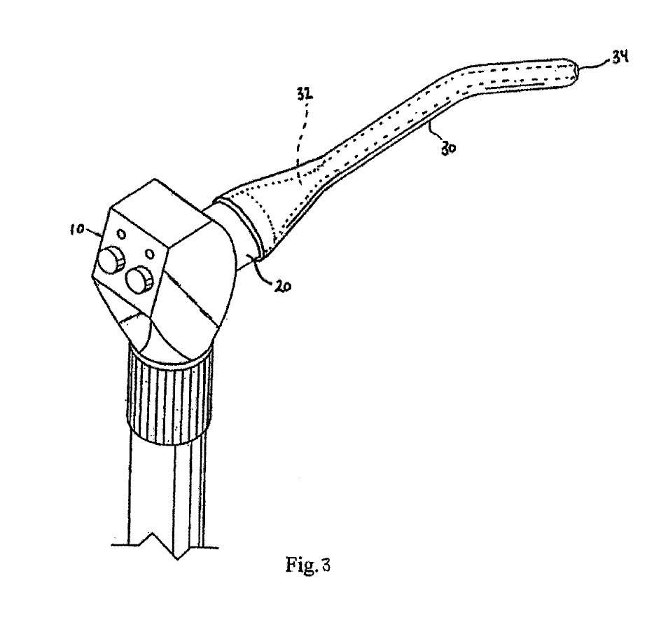

Referring now to FIG. 3, a conventional water/air syringe 10 is shown. Syringe 10 is commonly used by dentists to provide and evacuate liquids from the oral cavity during dental examinations and procedures. Syringe 10 is further used to provide compressed air, or a mixture of compressed air and compressed water to the patient's mouth. In some embodiments syringe 10 comprises an evacuator tip, such as a Yankauer suction tip, whereby a dentist removes liquids and debris from the oral cavity of a patient. An adapter 20 of syringe 10 generally provides a mounting surface whereby a disposable cover or tip 30 is temporarily fitted onto the syringe 10. An interior lumen 32 of tip 30, shown in phantom, is in fluid communication with syringe 10 such that water and air are easily provided to the patient from syringe 10 via an opening 34 provided in tip 30.

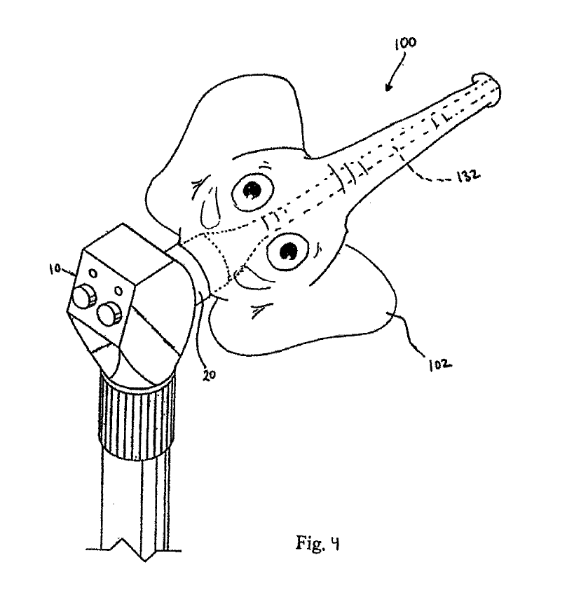

Referring now to FIGS. 4, a decorative tip 100 in accordance with the teachings of the present invention is shown as coupled to syringe 10. Unlike convention tip 30, decorative tip 100 comprises a molded outer surface 102 having a shape configured to portray an animal, such as an elephant. The shape of outer surface 102 is generally selected to portray an item or object that is visually pleasing to a patient. For example, in some embodiments outer surface 102 is shaped to portray an animal, a plant, a vehicle and/or a cartoon character. In other embodiments, outer surface 102 is configured to further include a color or combination of colors that is visually pleasing to the patient. For example, in some embodiments outer surface 102 comprises a color known to provide a calming or soothing effect to the observer. In other embodiments, outer surface 102 comprises a plurality of colors to portray further the selected shape of outer surface 102. One having ordinary skill in the art will appreciate that subject matter portrayed by outer surface 102 is not limited to the examples provided herein, but rather may include any portrayal and/or color that is visually pleasing to a patient. Outer surface 102 may further include any portrayal and/or colors that serve to sooth or otherwise reduce the anxiety of the patient during the dental visit.

In some embodiments, decorative tip 100 comprises an injection molded plastic material, such as polypropylene or polyethylene. In other embodiments, decorative tip 100 comprises a metallic material, such as stainless steel. In the molding process, tip 100 is provided with an interior lumen 132 having a proximal end diameter configured to compatibly receive adapter 20 of syringe 10. In some embodiments, lumen 132 is configured to receive an elongate adapter (not shown) wherein the adapter extends then entire length of lumen 132. Thus, in some embodiments tip 100 comprises a sleeve to cover and protect a non-disposable tip (not shown) permanently or removable coupled to syringe 10. In this way, tip 100 prevents contamination of adapter 20 thereby extending the time required between sterilization procedures of syringe 10.

In some embodiments a mechanical connection between tip 100 and adapter 20 is achieved through at least one of a pressure fit, a friction fit, and a threaded fit. In other embodiments, a fluid-tight connection between tip 100 and adapter 20 is achieved. For example, in some embodiments tip 100 is coupled to adapter 20 via a luer connection. In some embodiments, decorative tip 100 is disposable, while in other embodiments decorative tip 100 is sterilizable and/or reusable.

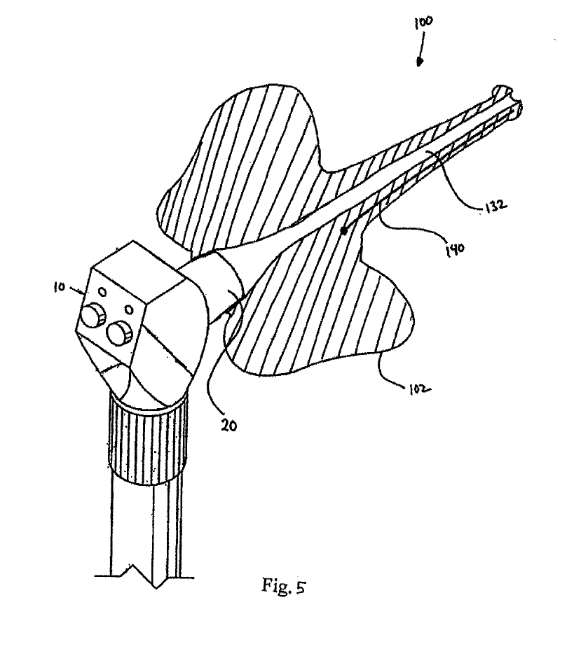

In some embodiments, decorative tip 100 comprises a rigid or semi-rigid material. In other embodiments, decorative tip 100 comprises a flexible or semi-flexible material that may be molded to conform to a desired shape or configuration. For example, in some embodiments tip 100 further comprises intermolded bendable members 140 that are plastically deformed by the user to achieve a desired shape or configuration for decorative tip 100, as shown in FIG. 5. In some embodiments, bendable member 140 comprises a metallic material, such as a metallic wire.

The present invention further relates to a method for alleviating or reducing the anxiety of a patient, such as a child-patient. In particular, the present invention relates to a method whereby a patient is given the option of choosing a decorative dental tip, the dental tip having a molded outer surface shaped to portray an object of interest to the patient, and a physician attaching the selected dental tip to a dental instrument thereby alleviating or reducing an anxiety of the patient related to the dental instrument.

In some embodiments of the present invention, a method for alleviating the anxiety of a patient is achieved by i) equipping syringe 10 with tip 100, wherein an outer surface of tip 100 is shaped to portray a subject that is visually pleasing to the patient. In other embodiments, a method for alleviating the anxiety of a patient is achieved through a series of steps whereby i) a patient is first offered an opportunity to select a desired tip, ii) the syringe 10 is equipped with the selected tip, and iii) the syringe 10 and desired tip are used for dental examination and/or procedures. Still further, in some embodiments a method for alleviating the anxiety of a patient is achieved through a series of steps whereby i) a patient is first offered an opportunity to select a desired tip, ii) the desired tip is then attached to the syringe 10, iii) the syringe 10 and desired tip are used for dental examination and/or procedures, and iv) the desired tip is removed from the syringe and given to the patient as a keepsake.

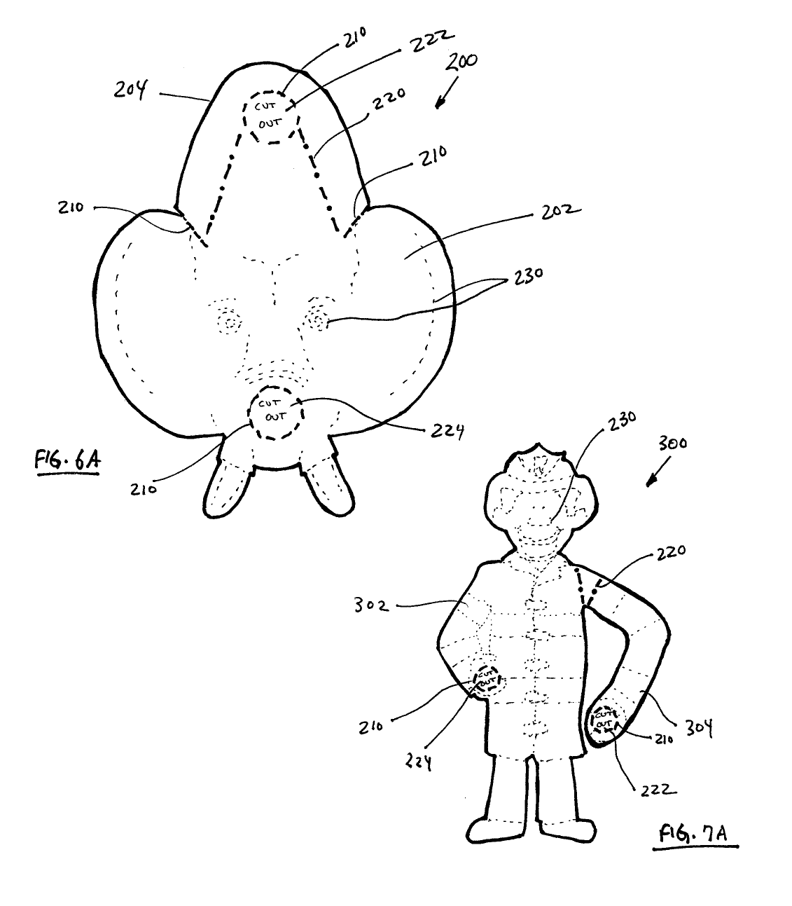

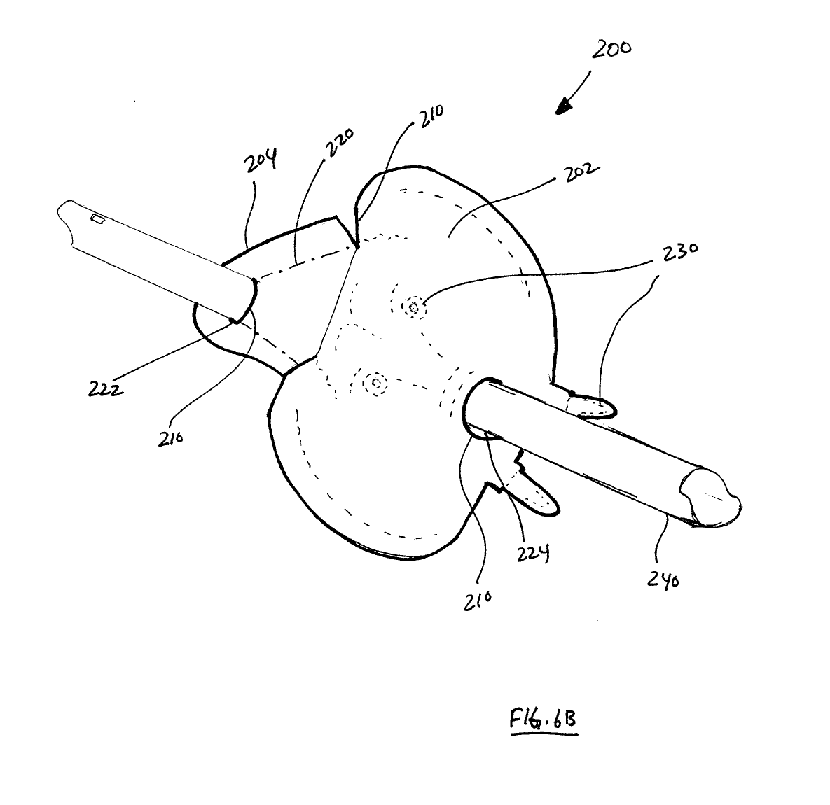

Referring now to FIG. 6, some embodiments of the present invention further include a system for decorating an exterior surface of a standard dental device. In particular, some embodiments comprise a decorative cut-out which is optimized for application to an exterior surface of a desired dental device. A decorative cut-out may include any size, shape, and/or pattern as may be desired to decorate a dental device. A decorative cut-out may further comprise any material or combination of materials as may be suitable for use as a decorative covering for a dental device.

Generally, a decorative cut-out comprises a rigid or semi-rigid material that is capable of maintaining a desired three-dimensional configuration once applied to the outer surface of a dental device. A compatible rigid or semi-rigid material may further be capable of receiving and maintaining a desired fold or crease as may be necessary to provide an intended three-dimensional shape or configuration. For example, in some instances a decorative cut-out comprises a paper material. In other instances, a decorative cut-out comprises a cardboard or cardstock material. Further, in some instances a decorative cut-out comprises a plastic material.

Referring now to FIG. 6A, a two-dimensional decorative cut-out 200 is shown. In some instances, a decorative cut-out 200 comprises a two-dimensional design or shape that includes a decorative portion or surface 202 and a structural support 204. The placement of structural support 204 in relation to decorative surface 202 is selected to facilitate placement of cut-out 200 onto or over the outer surface of a dental device thereby achieving a desired three-dimensional shape or other presentation of decorative surface 202 with respect to the dental device. Structural support 204 may include one or more apertures 222 which are sized to receive an outer surface of the dental device. Decorative surface 202 may further include one or more apertures 224 which are also provided to receive the dental device. Apertures 224 are further positioned on decorative surface 202 such that the placement of the dental device inserted therein correlates with the subject matter of the decorative surface 202.

Decorative cut-out 200 may further include various markings and other instructions which indicate where the user should cut 210 or fold 220 the cut-out to achieve an intended three-dimensional structure. For example, decorative cut-out 200 may include dashed lines 210 to indicate where the user is to cut or remove portions of cut-out 200. Decorative cut-out 200 may further include dash-dot-dash lines 220 to indicate where the user is to fold or crease the decorative surface 202. Decorative cut-out 200 may further include written instructions to direct the user in preparing and using the decorative cut-out.

Some embodiments further comprise a decorative design 230 which may be pre-printed and colored, or may be left blank such that the user may color the decorative design 230 as desired. In some instances, decorative cut-out 200 is printed onto a sheet of paper and manually cut out by the user. In other instances, decorative cut-out 200 is printed onto a sheet of paper and cut out by a die-cutting machine or other automated system. Further, in some instances decorative cut-out 200 is pre-manufactured and sold to an end-user as a ready-to-use product.

Decorative surface 202 may include any subject matter, color, pattern or other design as may be desired. In some instances, the size, shape and configuration of decorative surface 202 may be limited or otherwise restricted based upon the type or size of dental device for which the decorative cut-out 200 is designed and intended. In other embodiments, the subject matter, color, pattern or other design may be determined based upon the type of dental device for which the decorative cut-out 200 is designed and intended.

For example, where the dental device comprises a dental tip 240, the tubular nature of dental tip 240 may dictate that the subject matter of decorative cut-out 200 incorporate a tube-like feature. For example, a decorative cut-out 200 may include an animal design, wherein dental tip 240 is positioned within the cut-out 200 at a location that corresponds to a tube-like feature of the animal, such as the trunk of an elephant, as shown in FIG. 6B. Thus, once dental device 240 is inserted within apertures 222 and 224, decorative surface 202 and structural support 204 provide a three-dimensional structure which suggests that dental device 240 is part of the subject matter of decorative cut-out 200.

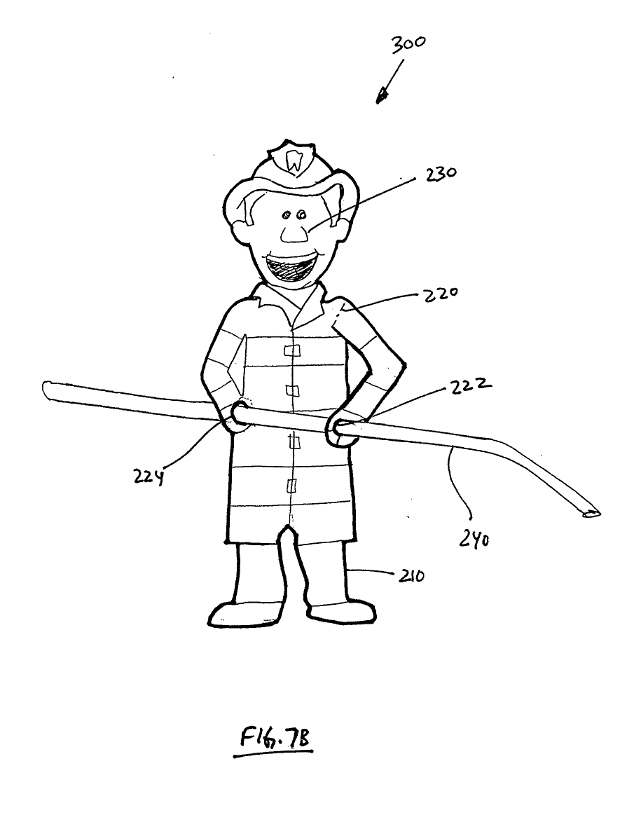

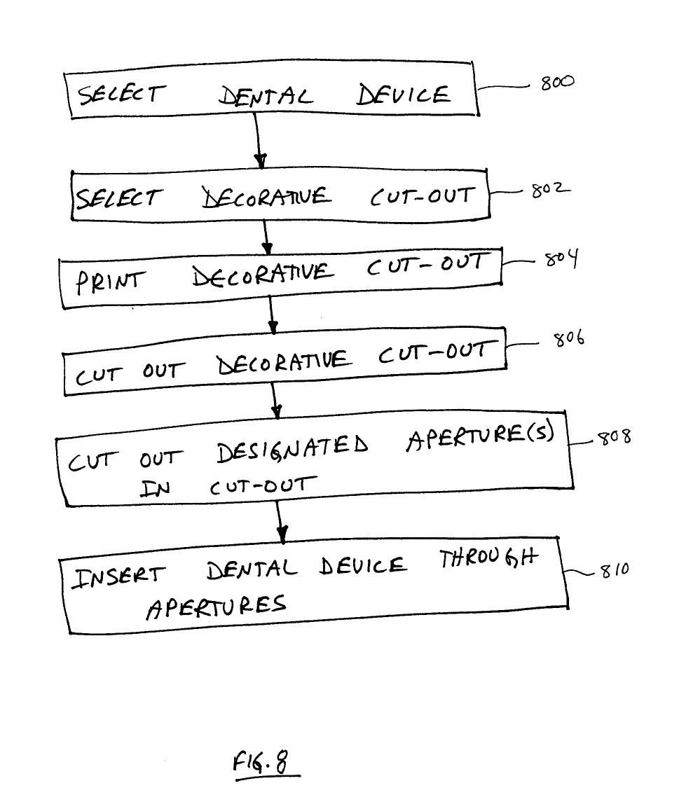

Referring now to FIG. 7A, decorative cut-out 300 may further include a decorative surface 302 that includes a support structure 304 which is incorporated into the subject matter of the cut-out 300. For example, support structure 304 may comprise a shape and configuration that 1) supports a portion of a dental device, and 2) completes or adds to an intended subject matter of the cut-out 300. As shown in FIG. 7B, aperture 224 is used in combination with aperture 222 to provide the left and right hands of a fireman design, wherein the hands hold a dental device 240 in a way that suggests the dental device 240 is a fire hose. Once dental device 240 is inserted into apertures 222 and 224, the fireman comprises a three-dimensional shape that supports dental device 240 in a desired position. In some embodiments, a decorative cut-out is provided which provides a three-dimensional structure capable of supporting a dental device in a desired position prior to, or following use of the dental device by a physician. Following use of decorative cut-out 200 or 300, the cut-out may be removed from the dental device and given to the patient as a souvenir.

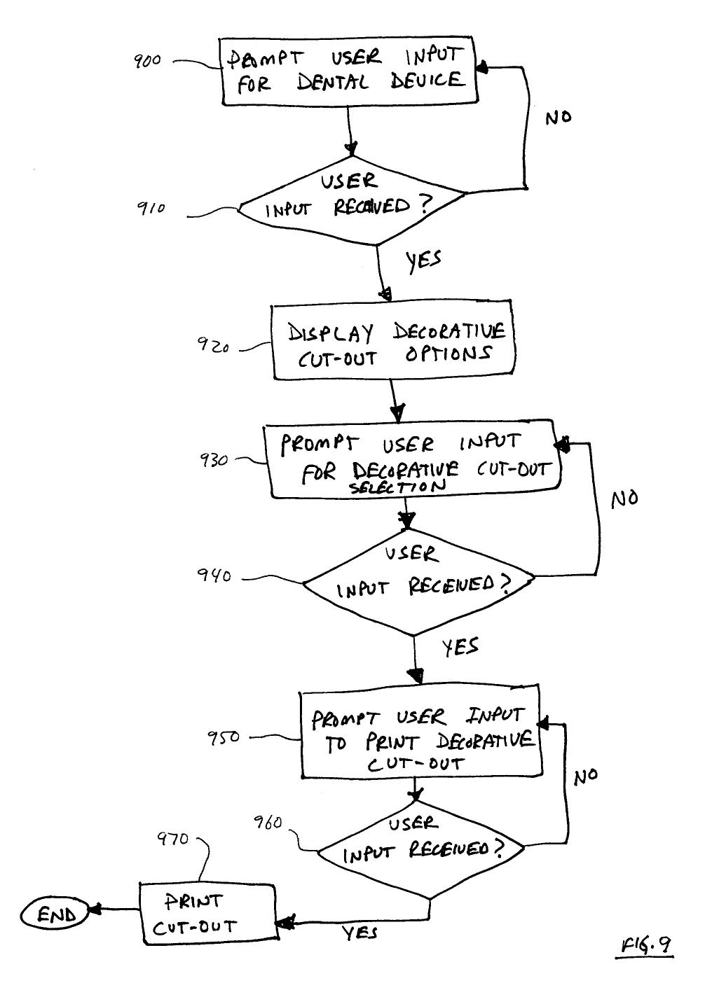

Referring now to FIG. 8, a method for selecting and providing a decorative cut-out in accordance with the present invention, is shown. In some embodiments, a healthcare professional may use a computer device having a computer executable instructions for selecting and printing a decorative cut-out. For example, a computer device may include a computer software program having computer executable instructions for providing a healthcare professional or other user with options for selecting a dental device. The computer device may comprise a database of known or compatible dental devices. The computer device may further comprises a customized database of dental devices which are used by the healthcare professional. The user may browse the database and select a dental device 800 for which a decorative cut-out is desired. The user is then presented with one or more compatible designs for the decorative cut out. The user selects a decorative cut-out 802 and the decorative cut-out is printed 804. In some embodiments, the user is required to cut out the printed decorative cut-out 806. In other embodiments, a die-cutting machine is used to cut out the printed decorative cut-out. The user or die-cutting machine further cuts out any designated apertures or other features that are necessary to accommodate the dental device 808. The user then inserts or otherwise fits the dental device onto or within the decorative cut-out 810.

Referring now to FIG. 9, a flowchart for a computer software program in accordance with a representative embodiment of the present invention is shown. In some embodiments, a computer software program is provided having computer executable instructions to prompt user input for selection of a dental device 900. Once an input has been received 910, the computer software program displays decorative cut-out options 920. The computer software program then prompts the user to input a decorative cut-out selection 930. Once an input has been received 940, the computer software program provides a prompt for the user to print the selected decorative cut-out 950. Once a user input has been received 960, the computer software program prints the cut-out 970. Alternatively, the computer software program may include instructions for sending the selected cut-out to a die-cutting machine whereby the cut-out is cut out as part of the printing process.

The present invention may be embodied in other specific forms without departing from its spirit or essential characteristics. For example, the present invention may be embodied in various other dental suction attachments. Thus, the described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A decorative cut-out device, comprising:
a decorative surface having at least one feature for supporting a first surface of a dental device; and
a structural support having at least one feature for supporting a second surface of the dental device.

2. The device of claim 1, wherein the decorative surface further comprises a decorative design.

3. The device of claim 2, wherein the decorative design comprises a subject matter which incorporates a structural element of the dental device.

4. The device of claim 1, wherein the structural support comprises a portion of the decorative surface.

5. The device of claim 1, wherein at least one of the structural support and the decorative surface further comprises a fold.

6. The device of claim 1, further comprising a two-dimensional structure.

7. The device of claim 6, wherein the two-dimensional structure of the device further comprises a three-dimensional structure when the first and second surfaces of the dental device are supported by the features for supporting the first and second surfaces.

8. The device of claim 1, wherein the at least one feature for supporting the first and second surfaces of the dental tool comprise an aperture.

9. The device of claim 1, further comprising a rigid or semi-rigid material.

10. The device of claim 1, further comprising a disposable device.

11. A method for manufacturing a decorative cut-out device, the method comprising:
selecting a dental device;
selecting a decorative cut-out;
printing a decorative cut-out; and
cutting out a printed decorative cut-out.

12. The method of claim 11, wherein the decorative cut-out comprises a decorative surface and a structural support.

13. The method of claim 12, wherein the decorative surface further comprises a decorative design.

14. The method of claim 12, wherein the decorative surface and the structural support each comprise at least one feature for supporting an outer surface of a dental device.

15. The method of claim 14, wherein the at least one feature comprises an aperture.

16. The method of claim 14, wherein the decorative design comprises a subject matter which incorporates a structural element of the dental device.

17. The method of claim 14, further comprising a step for folding the decorative cut-out to provide a three-dimension structure.

18. The method of claim 17, further comprising a step for inserting the dental device through each of the features for supporting the outer surface of the dental device of the three-dimensional structure.

19. A computer-implemented method for providing a decorative cut-out, the method comprising:
prompting a user for selection of a dental device;
receiving the user's input for selection of a dental device;
prompting the user for input for selection of a decorative cut-out;
receiving a user's input for selection of a decorative cut-out;
prompting the user for input for printing the selected decorative cut-out; and
printing the selected decorative cut-out.

20. The method of claim 19, further comprising a step for cutting out the selected decorative cut-out.
